(19) United States
(12) Patent Application Publication
(10) Pub. No.: US 2026/0054638 A1
(43) Pub. Date: Feb. 26, 2026

(54) APPARATUS, SYSTEM, AND METHOD OF PROVIDING HAZARD DETECTION AND CONTROL FOR A MOBILE ROBOT

(71) Applicant: JABIL INC., St. Petersburg, FL (US)

(72) Inventor: Charles Wolfe, St. Petersburg, FL (US)

(21) Appl. No.: 19/375,555

(22) Filed: Oct. 31, 2025

Related U.S. Application Data
(63) Continuation-in-part of application No. 19/299,562, filed on Aug. 14, 2025.
Application No. 19/299,562 is a continuation of application No. 19/174,493, filed on Apr. 9, 2025.
Application No. 19/174,493 is a continuation of application No. 17/044,018, now Pat. No. 12,298,773.
(60) Provisional application No. 62/650,545, filed on Mar. 30, 2018.

(51) Int. Cl. G05D 1/00; B60Q 1/46; B60Q 5/00; G05D 1/246; G05D 1/617

(52) U.S. Cl. CPC B60Q 1/46; B60Q 5/005; G05D 1/2465; G05D 1/617; G05D 1/633; G05D 1/637

(57) ABSTRACT

Systems and methods include: a mobile robot comprising a drive system, at least one image sensor; at least one infrared sensor, and an onboard processing system having at least one processor and a memory storing instructions; a store gateway communicatively coupled to the mobile robot and configured to receive an event record under a bandwidth-aware policy, to provide at least aspects of the event record for upload for storage to a cloud service, and to receive updates from the cloud service for the mobile robot; and an analytics module at the cloud service communicatively coupled to the store gateway and configured to perform analytics of uploaded ones of the event records.

### CROSS-REFERENCE TO RELATED APPLICATIONS

This application is a continuation-in-part of U.S. patent application Ser. No. 19/299,562 filed Aug. 14, 2025, which is a continuation of U.S. patent application Ser. No. 19/174,493 filed Apr. 9, 2025, which is a continuation of U.S. patent application Ser. No. 17/044,018 filed Sep. 30, 2020, which is a national stage application of International Patent Application No. PCT/US2019/024867 filed Mar. 29, 2019, which claims the benefit of priority to U.S. Provisional Application No. 62/650,545 filed Mar. 30, 2018, each of which is incorporated herein by reference as set forth in its entirety.

### FIELD OF THE DISCLOSURE

The disclosure relates generally to robotics, and, more particularly, to an apparatus, system, and method of providing hazard detection and control for a mobile robot.

### DESCRIPTION OF THE BACKGROUND

In any environment in which pedestrians are present, there exists a risk of personal injury to the pedestrians due to foreign material on the walking surface. This walking surface may be indoors or outdoors. In either an indoor or an outdoor setting, the costs may be significant when one of the aforementioned injuries to a pedestrian occurs. Such costs may include time costs, such as activity or employment time missed, as well as actual medical costs incurred by the injured party in attempting to get well, and additionally may include liability costs, such as to the owners of the environment in which the injury occurred. Indeed, liability costs incurred may be most significant in an indoor environment in which the foregoing referenced pedestrians are invited to walk, such as for a retail environment in which goods are for sale.

Indeed, each year, one of the most significant costs incurred in certain retail environments may include liability costs for pedestrian injuries that occur; insurance costs to protect the retain environment if injuries do occur; and preventative costs in an effort to prevent such injuries from happening. Many retail environments also choose to spend on other significant additional costs to improve the shopping experience in a retail environment. For example, some retail environments now make significant expenditures to purchase autonomous mobile robots, such as for restocking, safety, security, customer assistance, loss prevention, and the like.

However, it is obvious that expenditures targeted to provide shopper safety from walking hazards, and expenditures intended to improve the shopping experience, when taken together may provide an exorbitant cost that must be absorbed by the retail provider. Nevertheless, it is typically that case that the two significant costs mentioned above remain disassociated at this time for retail environment providers.

### SUMMARY

To address the aforementioned deficiencies, the disclosure provides systems and methods. Included is a mobile robot comprising: a drive system; at least one image sensor; at least one infrared sensor; and an onboard processing system having at least one processor and a memory storing instructions. When those instructions are executed by the at least one processor, the onboard processing system: acquires image data from the at least one image sensor and infrared data from the at least one infrared sensor while the mobile robot traverses a path through an environment using the drive system; detects in real time a hazard probability at locations along the traversed path by extracting characteristic hazard features from the image data and the infrared data; modifies the path of the mobile robot based on the hazard probability; and generates an event record comprising at least a timestamp, a robot pose, a hazard class, and a confidence value. Also included in the system and method are: a store gateway communicatively coupled to the mobile robot and configured to receive the event record under a bandwidth-aware policy, to provide at least aspects of the event record for upload for storage to a cloud service, and to receive updates from the cloud service for the mobile robot; and an analytics module at the cloud service communicatively coupled to the store gateway and configured to perform analytics of uploaded ones of the event records and download the analytics to the mobile robot through the store gateway to modify the detecting of the hazard probability upon subsequent occurrences.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1 illustrates aspects of the disclosure

FIG. 2 illustrates aspects of the embodiments;

FIG. 3 illustrates an aspect of the disclosure;

FIG. 4 illustrates an aspect of the disclosure;

FIG. 5 illustrates an aspect of the disclosure;

FIG. 6 illustrates an aspect of the disclosure;

FIG. 7 illustrates an aspect of the disclosure;

FIG. 8 illustrates aspects of the disclosure; and

FIG. 9 illustrates aspects of the disclosure.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical similar devices, systems, and methods. Those of ordinary skill may recognize that other elements and/or operations may be desirable and/or necessary to implement the devices, systems, and methods described herein. But because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

The terminology used herein is for the purpose of describing particular example embodiments only and is not intended to be limiting. For example, as used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another element, component, region, layer or section. That is, terms such as “first,” “second,” and other numerical terms, when used herein, do not imply a sequence or order unless clearly indicated by the context. Thus, a first element, component, region, layer or section discussed below could be termed a second element, component, region, layer or section without departing from the teachings of the exemplary embodiments.

Processor-implemented modules, systems and methods of use are disclosed herein that may provide access to and transformation of a plurality of types of digital content, including but not limited to video, image, text, audio, metadata, algorithms, interactive and document content, and which track, deliver, manipulate, transform and report the accessed content. Described embodiments of these modules, systems and methods are intended to be exemplary and not limiting. As such, it is contemplated that the herein described systems and methods may be adapted and may be extended to provide enhancements and/or additions to the exemplary modules, systems and methods described. The disclosure is thus intended to include all such extensions.

The embodiments address the significant costs in a retail environment of preventing pedestrian injury, and of providing mobile robotics for a variety of reasons, such as to improve the retail experience of consumers. That is, the embodiments use mobile robotics that may be dedicated to retail environment safety, or which may be present in a retail environment for reasons other than injury prevention, such as for security, restocking, inventory tracking, purchase advice, loss prevention, and so on, to aid in the prevention of pedestrian injuries within the retail environment.

More specifically, in the embodiments, an autonomous mobile robot may detect an urgent condition, and may accordingly perform one or more actions, such as alerting personnel to the urgent condition, wherein the one or more actions aid in the prevention of pedestrian injuries stemming from the urgent condition. As used herein throughout, an urgent condition may include a simple hazard, such as a spill, roof leak, or bottle breakage, or a more significant hazard, such as a partial roof or floor collapse, a shelving tip over, or a machine, such a forklift, operating in an area, by way of nonlimiting example.

Furthermore and by way of nonlimiting example, the robot may undertake not just one action, but may undertake combinations of multiple actions, such as proceeding to the location of the urgent condition and either remaining there until the issue is resolved, or until the robot has been automatically or manually released to return to normal activity. Of course, while at the location of the urgent condition, other actions may also include alerting pedestrians to the presence of the urgent condition so that pedestrians may avoid injury, such as through the use of lights, sounds, or combinations thereof, by way of nonlimiting example. The first and subsequent actions undertaken by the robot may be keyed to the occurrence of one or more triggers, and as such may be variable in accordance with an indication from one or more processing systems that at least partially control the robot.

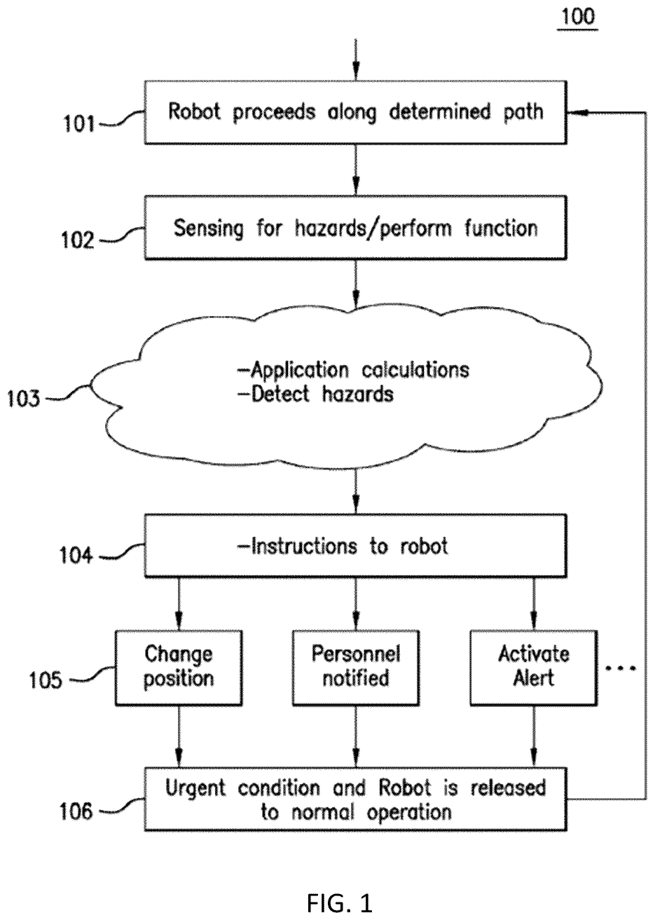

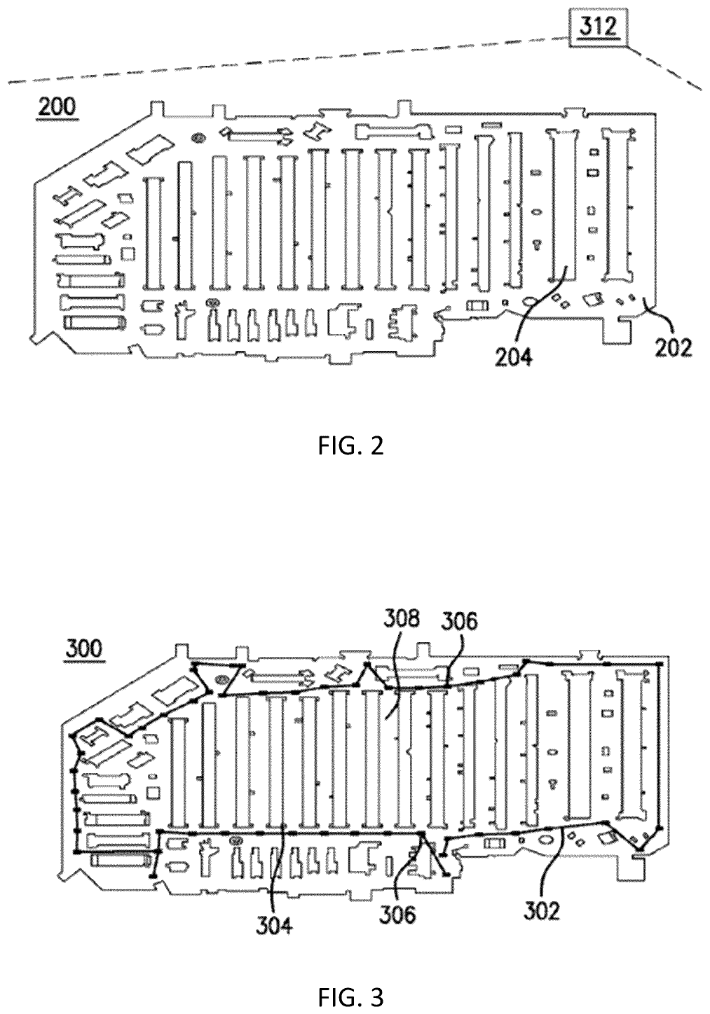

More particularly, FIG. 1 is a flows chart illustrating an injury prevention work flow method 100 for performance by an autonomous mobile robot, such as may be executed by a processing system at least partially onboard the robot. At step 101, the robot may follow a predetermined path, such as around a retail environment, such as may have been provided to the robot previously, such as via a data upload to the processing system, and which aids the robot in performance of its stated function. By way of nonlimiting example, FIG. 2 illustrates a visual representative of data that provides a map 200 of pathways 202 and obstacles 204 in a particular retail environment. Upon processing of the map 200 by the processing system 312 of the mobile robot of the embodiments, the map may, at least in part, allow for the robot to autonomously navigate to perform its stated function. Alternatively, the robot may “learn” an autonomously-generated path plan, such as an optimized path determined by the robot through the mapped space.

More particularly and with respect to FIG. 2, the darker areas indicated in the map may represent objects or areas of interest, such as obstacles 204, to the robot along its planned path. By way of example, such areas of interest may include shelving that blocks motion but which also includes products to be monitored or restocked by the robot; checkout lanes or cash registers; permanent static obstacles within the environment; and the like. In contrast, the white areas illustrated in FIG. 2 may represent open floor areas 202, such as may be readily traversed by the mobile robot absent intrusion of a dynamic obstacle, such as a pedestrian.

Of note, the mobile robot may be enabled to follow a randomized, dynamically-generated path along the open floor path areas 202, as shown by way of example in FIG. 2, or may be provided with a consistent, predetermined path along which the robot should navigate upon execution of the data representative of that path by the processing system 312 of the robot. Further, it will be understood, such as in the aforementioned case of a dynamic obstacle intruding upon pathway 202, that the processing system may include additional actions to be undertaken by the robot in such cases.

More particularly, FIG. 3 illustrates an additional exemplary map 300 having a path plan 302 for navigating about the map 300 by a mobile robot. It will be appreciated that the path plan line 302 around obstacles 304 on the map 300 is representative of the path for the robot, and ones of the blocks 306 along the path 302 may illustrate locations whereat the robot may perform its stated function(s), such as taking pictures for security or loss prevention purposes, or taking pictures for hazard detection along the open aisles 308.

It should be noted that data may be gained by the robot at these function points 306 along its planned path 302, such as to enable the robot to perform its stated function. By way of nonlimiting example, at each block position 306 along the path 302, the robot may sense, such as by sensors, cameras, or the like, its position along a spatial axes (X, Y, Z), and/or its orientation in space (i.e., role, pitch, yaw). That is, either as the robot traverses its planned path 302, or at stopping points 306 along the path 302, or at both, the robot may assess various data points, such as the aforementioned six degrees of freedom for movement of the robot, and may feed this data to the processing system 312, such as to allow for performance of the method in accordance with the example of FIG. 1. Of course, it will be appreciated that various other data points may be taken and/or sensed by the robot, such as temperature, light levels, vibration levels, and so on, and in addition the robot may obtain data unrelated specifically to the position or operation of the robot, but instead related to its stated function, such as empty shelf space, number of persons in an aisle, detection of identifications, such as RFIDs, of as yet unpurchased items in a cart, and so on.

Returning now to the exemplary method 100 of FIG. 1, the robot may perform a function, such as hazard detection, such as by taking one or more pictures, or spectrographic or infrared assessments, at the stopping points 306 shown on the map of FIG. 3, or at other locations indicated by the path plan. This information may be fed to the processing system 312, such as the onboard, partially onboard, or off board robotic processing system, for analysis. By way of nonlimiting example, the obtained data at step 102 may be provided to one or more on board applications 490, or off board applications in the cloud, for analysis, such as image analysis or spectrographic or infrared analysis. In short, at step 102, data, which may be in addition to the data obtained by the robot in performance of the stated function, may be obtained for the purpose of hazard detection, and is provided to the processing system 312 for use by one or more applications onboard, partially off board, or off board the robot to analyze the data for hazard detection.

In further embodiments consistent with the disclosure herein, and in relation to, among other steps, step 102 of exemplary method 100, a distributed processing architecture may be implemented in which onboard processing on the mobile robot 106 cooperates with store-resources and cloud services to achieve real-time hazard detection, navigation, and reporting without saturating the store network(s). In particular, distributed processing system 312 (which may include or cooperate with the onboard processing system 120) executes latency-sensitive perception and control tasks locally, while bandwidth-intensive storage, model training, retrospective analytics, and fleet orchestration may be performed offboard at an edge gateway and/or in the cloud. The distribution of functions preserves deterministic robot behavior even under constrained or intermittent store connectivity, while still enabling cross-store learning, global storage access, and auditability.

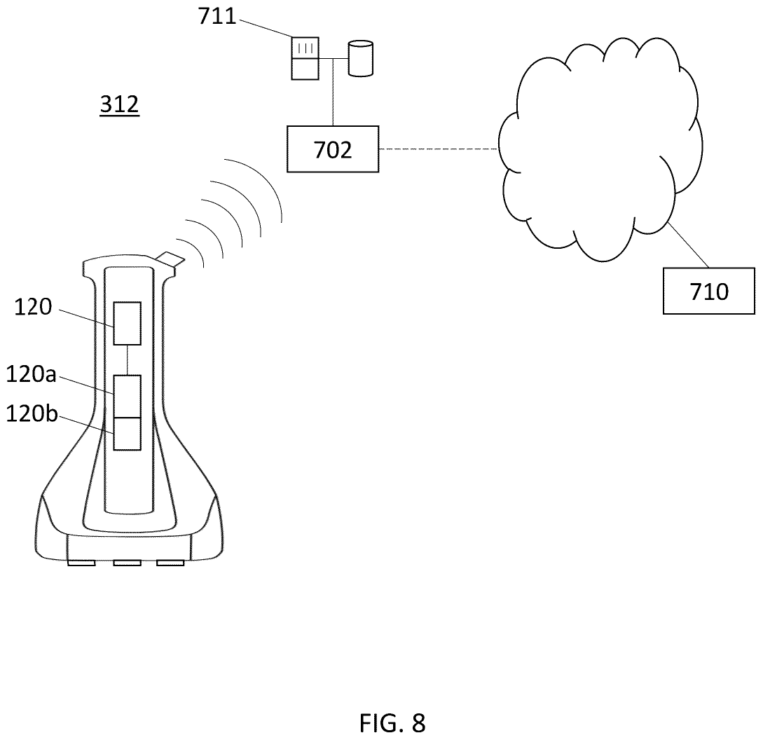

FIG. 8 illustrates an exemplary hybrid cloud/edge architecture 312. The mobile robot 106 includes the onboard processing system 120 and one or more memories storing non-transitory code to execute algorithms, calculations, comparisons and relations as described herein. The robot communicates with a store server or gateway 702, which provides durable storage, local policy enforcement, model staging, and opportunistic synchronization to a cloud service 710. Sensor outputs stream into an onboard perception stack 120a for hazard detection, obstacle classification, and path planning. Compact event records (e.g., “spill detected,” “blocked aisle,” “overhanging hazard”) may be written to a local queue 120b for immediate action. Larger events entailing significant data and/or data best served to the entire fleet may be uploaded to the store server 711 or through the gateway using bandwidth-aware streaming so that ordinary store operations the use the network remain unaffected.

Returning now to method 100, the robot processor 120 may execute: real-time image processing and depth fusion onboard to generate hazard cues within a bounded control cycle (e.g., 30-80 ms); near-horizon mapping and updates onboard to maintain safe navigation around and tracking of dynamic obstacles in real time; event encoding to produce descriptors for store staff notification and action; and periodic upload of buffered data to the gateway 702, or upload when the gateway signals available bandwidth. The gateway may aggregate local logs across a shift; maintain versioned models, algorithms and configuration for that store for periodic download to the robot processor 120; and periodically synchronize with cloud 710, whereat historical analytics, cross-store learning, and fleet policy rollouts are performed.

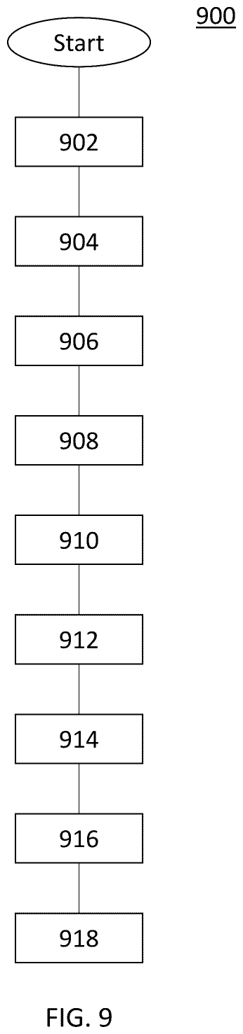

FIG. 9 depicts a flow 900 for hybrid/distributed processing. At 902, the robot 106 may acquire frames (image, spectrographic, infrared) and depth. At 904, the onboard perception stack 120a may perform feature extraction, segmentation of floor and obstacle classes, and detection for indicators of hazards such as liquid sheen, debris, radiating under UV light, or damaged fixtures, by way of example. At 906, the processing system 312 may fuse hazard probabilities to the robot's local map, and navigation may update the path plan accordingly at 908. At 910, event records and large scale data to be retained are compressed and staged to the local queue 120b. At 912, the gateway 702 accepts staged items under a buffer policy that limits peak bandwidth usage and prioritizes feedback and fleet-relevant information over of bulky imagery data. At 914, the cloud 710 may perform batched analytics, model retraining, and cross-store pattern mining. At 916, updated models and policy and action changes may be published to the gateway 702, and at 918 the robot 106 may receive and activate such updates and changes under a safe application mandate (i.e., with an automatic rollback if confidence or performance regresses).

In some embodiments, the division of labor between the robot 106, the gateway 702, and the cloud 710 may be adaptive to the network state. For example, where store connectivity is poor or intermittent, the robot 106 may lean yet more heavily on onboard processing, executing all principal hazard detection, obstacle classification, and navigation locally, and retaining a longer rolling window of logs and imagery. When connectivity improves (e.g., after hours or when the network is back up), the store gateway 702 may pull the robot's backlogged data and synchronize to the cloud 710. Conversely, in stores with robust connectivity, the robot 106 may offload non-urgent batch items not affecting the current robot run (e.g., feedback, medium and long-term analytics) more frequently, while continuing to keep all time-critical control onboard to preserve real-time responsiveness.

The architecture and method of FIGS. 8-9 further reduce risk by discretizing errors and faults. For example, if a misconfiguration or malware event occurs in an offboard system, only the gateway 702 or the cloud 710 is affected until upload to the robot 106, so the robot continues to operate on its last known-good model and configuration. Conversely, if a failure occurs on the local robot processor, it is isolated to that single robot, and the remainder of the fleet continues unhindered.

The distributed processing allows event encoding used for hazard and obstacle reporting and for navigation to be data-compact and robust under constrained bandwidths typical of retail. For example, rather than streaming full-frame video on the in-store network, the robot 106 may compute a hazard onboard from the video/images comprising timestamp, pose and position, hazard class (e.g., liquid spill, moving cart), and a confidence value, to enable real-time decision making onboard the robot, but may solely upload the decision and data characteristics that led to the decision, and/or an indicative image crop or compressed data, to the cloud. Associates may receive the alert through in-store systems, but with the same compact record persisted at the gateway 702 that is ultimately provided to the cloud. Where privacy policies require, retained imagery may be pre-redacted onboard, such as blurring faces and/or sensitive signage before storage or transmission.

In a non-limiting example, the robot 106 may detect a thin liquid sheen in a freezer aisle using imagery, infrared and polarization sensing. This may be data-fused with the downward-facing depth sensor to confirm a surface anomaly that is a probable hazard to the tune of 86% confidence. A data-compact event record is thus emitted for associates to attend to the hazard, while a single frame crop and the compact event record is queued for upload via the gateway 702. Overnight, the cloud 710 receives the event record and frame crop to a feedback-based model retraining module.

In yet another example, the store requests of the robot a regular hazard sweep near the front entrance. To manage bandwidth, hazards are detected and responded to onboard, and the robot opportunistically offloads only positive data (e.g., positive hazard confirmations) to the gateway, but negative data may be expunged onboard at a predetermined timeframe, and may never be uploaded or may have only a sampling thereof uploaded (such as to allow for remote performance monitoring and feedback).

Thus, as per the discussion above indicating that the onboard processing system 120 may handle all principal processing or may share principal processing at least partially or fully off board the robot 106, “sharing” may preferably be orchestrated so that real-time control (obstacle/hazard perception, motion planning, stop-run enforcement) remains onboard, while storage, large-scale data, analytics, and fleet choreography may be offboarded subject to bandwidth constraints and/or data policy. This division significantly reduces in-store bandwidth consumption, decreases storage costs, and ensures that a single adverse event in the offboard environment cannot globally incapacitate the fleet.

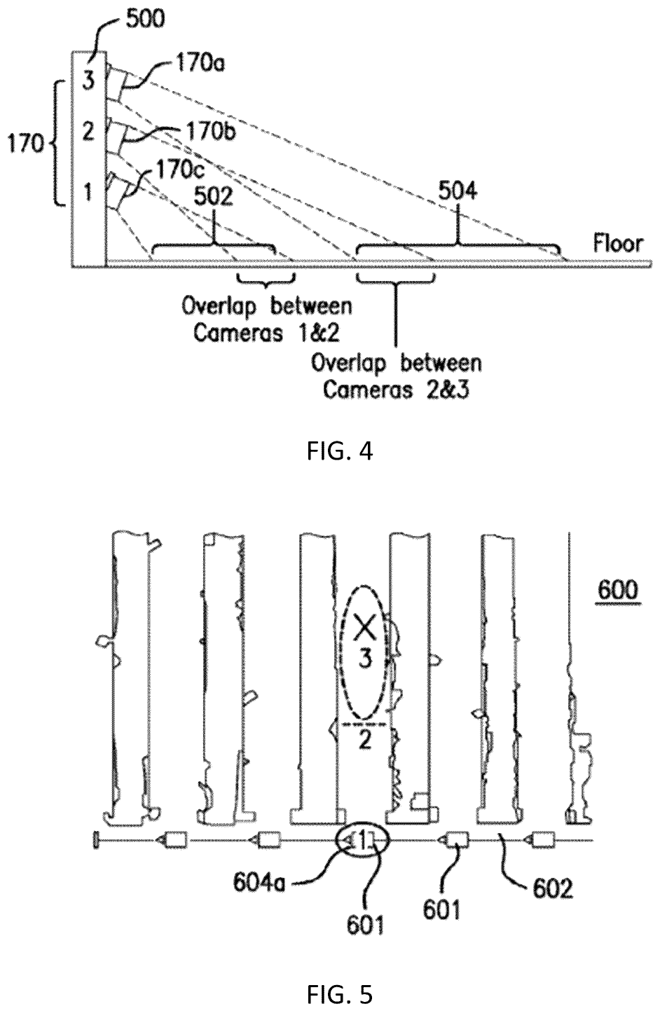

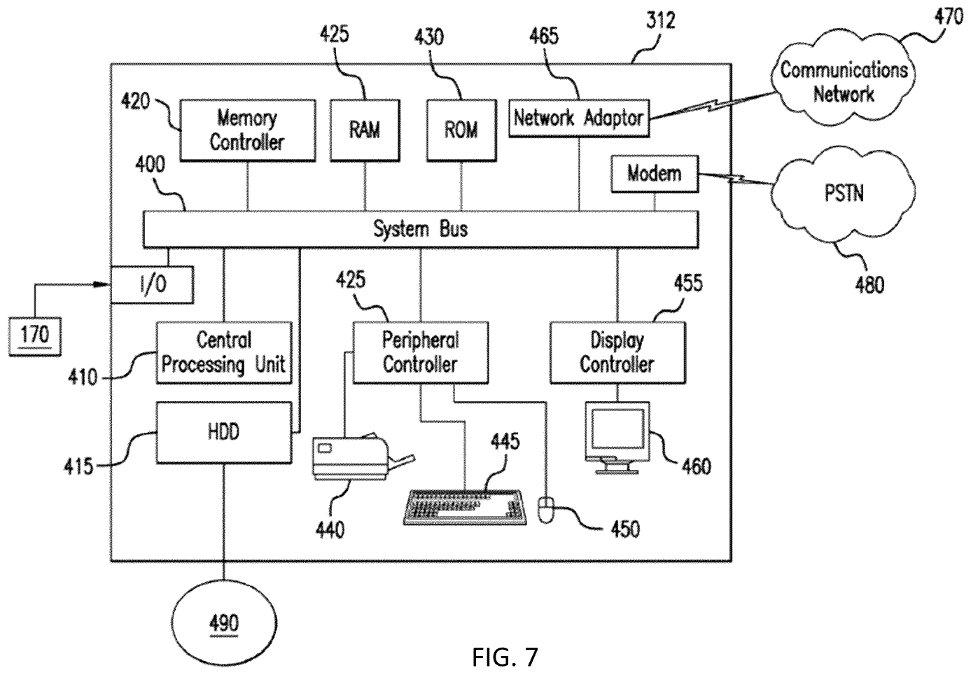

FIG. 4 illustrates an exemplary embodiment of the obtaining of hazard data, such as may be performed at step 102 of FIG. 1. In the illustration, the sensors 170, such as cameras, onboard the robot 500 provide the robot with a field the view 502, 504, of one or more areas of the floor along the open areas in a retail environment. Of note, a single camera may provide a given field of view, while an array of cameras 170 a, 170 b, . . . , may be employed, such as in an overlapping manner, to provide a field of view. As such, it will be understood that, in accordance with the disclosure, an array of sensors or a single sensor may be employed to perform the hazard detection of step 102. It will be appreciated that the hazard detection may require further sensor data processing by the referenced application 490 (see FIG. 7), such as wherein a hazard is detected across multiple images from the array of cameras 170 a, 170 b but the multiple images must be overlaid by the application 490 in order to assess the extent of the hazardous condition.

Returning now to the method of FIG. 1, the application 490 may analyze the received sensor output 170, and may use this information to detect one or more hazardous conditions. Other data beyond that provided by the sensors 170 may be received by the application 490 in accordance with the embodiments, such as the position of the robot on the navigation map 300, the physical position of the robot in relation to its six degrees of freedom as discussed above, or the like. Moreover, the other aspects provided by application 490 may include an artificial intelligence (AI), which may act in place or, or in conjunction with, the herein-discussed application 490 to assess the presence of hazards/obstacles. This may further enable refined detection and assessment of the urgent condition and its location within the retail environment. Also, in accordance with this step 103, if a hazard is detected the application 490 may provide an urgent notification to the robot, such as may include an action or additional action to be taken by the robot, such as to update the position of the robot to block or otherwise indicate to pedestrians the presence of the hazard, the actuation of the aforementioned alerts, such as lights or sounds, by the robot, and so on.

FIG. 5 is a visual representation of data that provides a map 600 on which is detected and located a hazardous condition. More particularly, the “X” in FIG. 5 indicates the presence of an urgent location. The circled “1” indicates the sensing location 601 of the robot along its planned path 602 whereat the set of images represented by the data were uploaded to the application 490 which contain the image of the hazardous condition.

As referenced above with respect to step 103, based on the circle and the “X” within the data generated by the robot, the application 490 may elect what action or actions the robot should undertake; or these actions may be pre-stored at the robot based on the presence of triggers within the data obtained by the robot. By way of example of actions, the robot may first be sent back to the position whereat the picture indicating the urgent condition was generated. This is indicated by the stopping point block 604 a within the circle of FIG. 5.

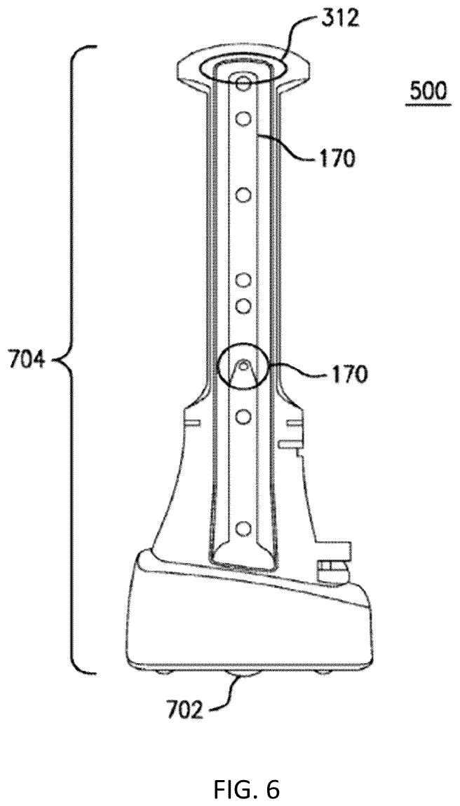

Additionally and alternatively, by more refined analysis of the received data, the application 490 may provide the robot with an action to move to a position closer to the hazard. By way of example, in a camera-sensing robotic embodiment, the application 490 may appreciate the intrinsic geometries of the fields of view for each of the cameras in the array, and thereby may be enabled to assess, such as based on the overlap of the field of view between the cameras, a highly refined position at which the urgent condition exists. By way of example, the position numeral “2” in FIG. 5 may indicate the first position at which an overlap between cameras in the field of view (shown by way of example for the camera array of FIG. 4) locates the hazard (shown by the dotted line field of view in FIG. 6). Accordingly, as the application 490 may assess this as the threshold that approximates the location of the hazardous condition, and the correspondent action indicated to the robot may then be to move to the position indicated by position numeral “2” in FIG. 5.

Of course, the data received by the application 490 from the sensors 170 may allow for a yet-more refined analysis than that referenced immediately above. More particularly, the sensors may enable the application 490 to determine a very highly precise location of the hazardous condition on the path plan map 600. Using this information, the application 490 may calculate, such as based on sensor data received 170, such as may include the intrinsic properties for one or more images from a camera or camera array, a very precise location where the hazard condition exists. This calculation by the application 490 is represented by the position numeral “3” in FIG. 5. Of course, the application may indicate to the robot that the robot reposition at position numeral “3” in circumstances in which, for example, the robot is to entirely block the hazardous condition such that pedestrians are disabled from encountering the hazardous condition.

Returning now to the embodiment of FIG. 1, at step 104 the robot may have been notified by the application 490 of the urgent scenario, and/or of the new position the robot is to undertake. Additionally, the robot may be provided with additional instructions to address the urgent condition. By way of example, the robot may be provided by the application 490, and/or by its pre-stored processing system 312 response to triggers, with multiple actions to be undertaken in order to protect pedestrians from the hazardous condition and to notify personnel of the necessity of treating the hazardous condition.

For example, at steps 104 and 105, the robot may be instructed to change its navigation path to move to the position indicated by the application 490, as discussed above. Additionally, the robot may provide a notification, such as to in-store personnel or to external personnel, such as may be available by one or more networked communications, such as over the Internet. Such a notification at steps 104 and 105 may include the sending of one or more messages via various communication means, such as by email and to one or more mobile devices, that the hazardous condition is present. Needless to say, it may be desired that redundancy occurs in such communications, such that multiple devices belonging to multiple personnel, such as via email and mobile communication, are automatically contacted in the embodiments, and such as mandating that multiple types of personnel, such as in-store and out-of-store, be contacted by the application 490 for all urgent conditions, or only if given urgent conditions occur.

Further, other actions may be directed and undertaken at steps 104 and 105, such as via onboard wired or wireless communication, such as by posting a message to an internal public address system; by the actuation of lights or sounds associated with the robot; and/or by the robot itself serving as a public address system, such as by providing a pre-recorded message, such as may be based on the hazardous condition sensed. Other actions may include instructions from the application 490, and/or instruction from one or more external locations connective to the processing system 312. These remote instructions may or may not be provided through the application 490, and may or may not arrive wirelessly at the robot.

As is further illustrated at step 105, the robot may undertake one or more actions, such as those indicated above, as indicated by the analysis by the application 490 (and/or a remote monitor) at step 104. For example, in performance of the actions, the robot may take up a new position indicated by the application; may flash lights, play sounds, and/or may play a warning message; may wirelessly provide a message to the in-store public address system to allow for the playing of an audible message announcing the presence of the hazardous condition; and/or may notify in-store or out-of-store personnel of the presence of the hazardous condition, by way of nonlimiting example. Of course, it will be understood, based on the discussion herein, that a variety of other actions may be undertaken by the robot at the instruction of the application 490, and/or based on the instruction by external or in-store personnel, and that the disclosure is not limited to the examples provided herein.

At step 106, the robot has successfully undertaken its action, and may accordingly automatically release itself to normal operation, such as after a predetermined time period or pursuant to sensing a different condition, such as the lack of the previous urgent condition; or may be manually released to its normal operation, such as by manual indication of the resolution of the hazardous condition to the robot from in-store or out-of-store personnel. In either case, such as following execution of all indicated actions, the robot may resume normal operation along its planned path for the performance of its stated function, such as the exemplary path illustrated in FIG. 3.

FIG. 6 illustrates, by way of nonlimiting example, a robot 500 suitable for operation in accordance with the disclosed embodiments. More particularly and as shown, the robot 500 includes one or more wheels 702 in the body 704 thereof suitable to move the robot 500 about its plan path; one or more sensors 170, such as cameras, suitable for the robot to perform its stated function, and sense hazardous conditions; and one or more processing systems 312, such as may include wireless communication with external network environments, to allow the application to perform its functions as stated herein.

FIG. 7 depicts an exemplary computer processing system 312 for use in association with the embodiments, by way of non-limiting example. Processing system 312 is capable of executing software, such as an operating system (OS) and the one or more computing algorithms/applications 490, such as those for the processing of inputs received from sensors 170 discussed throughout. The operation of exemplary processing system 312 is controlled primarily by these computer readable instructions/code 490, such as instructions stored in a computer readable storage medium, such as hard disk drive (HDD) 415, optical disk (not shown) such as a CD or DVD, solid state drive (not shown) such as a USB “thumb drive,” or the like. Such instructions may be executed within central processing unit (CPU) 410 to cause system 312 to perform the disclosed operations, comparisons and navigation calculations. In many known computer servers, workstations, personal computers, and the like, CPU 410 is implemented in an integrated circuit called a processor.

It is appreciated that, although exemplary processing system 312 is shown to comprise a single CPU 410, such description is merely illustrative, as processing system 312 may comprise a plurality of CPUs 410. Additionally, system 312 may exploit the resources of remote CPUs (not shown) through communications network 470 or some other data communications means 480, as discussed above.

In operation, CPU 410 fetches, decodes, and executes instructions from a computer readable storage medium such as HDD 415. Such instructions may be included in software such as an operating system (OS), executable programs/applications 490, and the like. Information, such as computer instructions and other computer readable data, is transferred between components of system 312 via the system's main data-transfer path. The main data-transfer path may use a system bus architecture 405, although other computer architectures (not shown) can be used.

Memory devices coupled to system bus 405 may include random access memory (RAM) 425 and/or read only memory (ROM) 430, by way of example. Such memories include circuitry that allows information to be stored and retrieved. ROMs 430 generally contain stored data that cannot be modified. Data stored in RAM 425 can be read or changed by CPU 410 or other hardware devices. Access to RAM 425 and/or ROM 430 may be controlled by memory controller 420.

In addition, processing system 312 may contain peripheral communications controller and bus 435, which is responsible for communicating instructions from CPU 410 to, and/or receiving data from, peripherals, such as peripherals 440, 445, and 450, which may include printers, keyboards, and/or the elements discussed herein throughout. An example of a peripheral bus is the Peripheral Component Interconnect (PCI) bus that is well known in the pertinent art.

Display 460, which is controlled by display controller 455, may be used to display visual output and/or presentation data generated by or at the request of processing system 312, responsive to operation of the aforementioned computing programs/applications 490. Such visual output may include text, graphics, animated graphics, and/or video, for example. Display 460 may be implemented with a CRT-based video display, an LCD or LED-based display, a gas plasma-based flat-panel display, a touch-panel display, or the like. Display controller 455 includes electronic components required to generate a video signal that is sent to display 460.

Further, processing system 312 may contain network adapter 465 which may be used to couple to external communication network 470, which may include or provide access to the Internet, an intranet, an extranet, or the like. Communications network 470 may provide access for processing system 312 with means of communicating and transferring software and information electronically. Additionally, communications network 470 may provide for distributed processing, which involves several computers and the sharing of workloads or cooperative efforts in performing a task, as discussed above. Network adaptor 465 may communicate to and from network 470 using any available wired or wireless technologies. Such technologies may include, by way of non-limiting example, cellular, Wi-Fi, Bluetooth, infrared, or the like.

In the foregoing Detailed Description, it can be seen that various features are grouped together in a single embodiment for the purpose of clarity and brevity of the disclosure. This method of disclosure is not to be interpreted as reflecting an intention that the embodiments require more features than are expressly recited herein. Rather, the disclosure is to encompass all variations and modifications to the disclosed embodiments that would be understood to the skilled artisan in light of the disclosure.

What is claimed is:

1. A system comprising:
a mobile robot comprising:
acquire image data from the at least one image sensor and infrared data from the at least one infrared sensor while the mobile robot traverses a path through an environment using the drive system;
detect in real time a hazard probability at locations along the traversed path by extracting characteristic hazard features from the image data and the infrared data;
modify the path of the mobile robot based on the hazard probability; and
generate an event record comprising at least a timestamp, a robot pose, a hazard class, and a confidence value;
a store gateway communicatively coupled to the mobile robot and configured to receive the event record under a bandwidth-aware policy, to provide at least aspects of the event record for upload for storage to a cloud service, and to receive updates from the cloud service for the mobile robot; and
n analytics module at the cloud service communicatively coupled to the store gateway and configured to perform analytics of uploaded ones of the event records and download the analytics to the mobile robot through the store gateway to modify the detecting of the hazard probability upon subsequent occurrences.

2. The system of claim 1, wherein the at least one infrared sensor comprises a depth sensor.

3. The system of claim 1, wherein the detecting the hazard probability comprises detecting a liquid sheen on flooring along the path.

4. The system of claim 1, wherein the event record further comprises a cropped image.

5. The system of claim 1, wherein the bandwidth-aware policy prioritizes small actionable messages ahead of bulk imagery.

6. The system of claim 1, wherein the cloud service downloads fleet-wide retraining based on the analytics of aggregated ones of the event records.

7. The system of claim 6, wherein the retraining rolls back a prior model due to aggregated low confidence values.

8. The system of claim 1, wherein the onboard processing system maintains a buffer of the event records and the image data and opportunistically uploads the buffering upon availability of bandwidth by the store gateway.

9. The system of claim 1, wherein the onboard processing system performs privacy redaction of the image data upon the buffering.

10. The system of claim 1, wherein division of processing between the onboard processing system and the cloud service is adaptive based on a state of the communicative coupling.

11. A method for hazard detection by and navigation of a mobile robot, comprising:
acquiring, by at least one image sensor and at least one infrared sensor of the mobile robot, image data and infrared data while the mobile robot traverses an environment;
detecting, by an onboard processing system of the mobile robot, a hazard by recognizing hazard characteristics in the image data and the infrared data;
updating, by the onboard processing system, a navigation plan of the mobile robot based on the detection of the hazard;
generating, by the onboard processing system, an event record of the hazard comprising at least a timestamp, a robot pose and positions, and a confidence value;
storing the event record in a local queue on the mobile robot;
uploading, under a bandwidth-aware policy, at least the event record from the mobile robot to a store gateway;
synchronizing, from the store gateway to a cloud service, the event record for storage and analytics; and
downloading, from the cloud service via the store gateway to the mobile robot, action policy updates for hazard detection based at least one the analystics.

12. The method of claim 11, further comprising detecting the hazard by correlating an anomaly in the image data with a sheen in the infrared data.

13. The method of claim 11, further comprising redacting the image data onboard the mobile robot based on a privacy policy.

14. The method of claim 11, wherein the event record further comprises at least one cropped image of the image data.

15. The method of claim 11, wherein the uploading under the bandwidth-aware policy comprises prioritizing the event records over bulk data based on available bandwidth.

16. The method of claim 11, further comprising adapting a division of labor such that, during degraded connectivity, the mobile robot performs substantially all the detection of hazards, real-time decisions on the navigation, and elections of data buffering and, upon restored connectivity, opportunistically offloads buffering.

17. The method of claim 11, further comprising emitting from the mobile robot at least one associate-facing alert based on the detection of the hazard.
